(19) United States
(12) Patent Application Publication
(10) Pub. No.: US 2025/0121673 A1
(43) Pub. Date: Apr. 17, 2025

(54) SPHERICAL ROBOT

(71) Applicants: Bruno BELZILE, Laval (CA); David ST-ONGE, Greenfield Park (CA)

(72) Inventors: Bruno BELZILE, Laval (CA); David ST-ONGE, Greenfield Park (CA)

(21) Appl. No.: 18/730,450

(22) PCT Filed: Jan. 23, 2023
(86) PCT No.: PCT/CA2023/050071

§ 371 Date: Jul. 19, 2024

Related U.S. Application Data
(60) Provisional application No. 63/301,561, filed on Jan. 21, 2022.

(51) Int. Cl. B60K 7/00; B60B 19/14; B62D 9/02

(52) U.S. Cl. CPC B60K 7/0007; B60B 19/14; B62D 9/02; B60K 2007/003; B60K 2007/0053; B60K 2007/0061

(57) ABSTRACT

A robot may have a sphere-like outer shell defining an inner cavity. An axle unit includes an axle connected at its opposed ends to the outer shell, in the inner cavity, and a transmission to transmit a torque to the axle. A pendulum drive unit is operatively connected to the axle unit and supported in the outer shell by the axle, the pendulum drive unit having actuators to produce torque, the actuators operatively connected to the transmission of the axle unit. The axle unit and the pendulum drive unit concurrently define a cylindrical joint by which the pendulum drive unit is movable in rotation and translation relative to the axle to tilt and drive the sphere-like outer shell via the actuators.

### CROSS-REFERENCE TO RELATED APPLICATION

The present application claims the priority of U.S. Patent Application No. 63/301,561, filed on Jan. 21, 2022, the contents of which are incorporated herein by reference.

### TECHNICAL FIELD

The application relates to spherical rolling robots.

### BACKGROUND

Alternatives to traditional wheeled robots have been studied for space exploration, as they are not necessarily adapted for the challenging terrain topology that can be found on other planets or satellites. Instead of relying on a legged robot, it may be desired to consider a spherical rolling robot dropped near a targeted area to explore it. The spherical shape of the robot grants it good maneuverability, is well suited to protect its internal equipment, such as motor, sensors and computer, from potential collisions as well as to seal it off from the harsh exterior environment.

Spherical rolling robots have been developed for various applications, ranging from child-development studies to underwater exploration and agriculture. Some are also commercially available, commonly sold as toys to learn robotics. While there are as many spherical rolling robot designs as there are specific sets of characteristics, their locomotion systems are often part of three broad categories: 1) barycentric; 2) conservation of the angular momentum; and 3) shell deformation.

In barycentric spherical robots (BSR), to drive the rolling motion, the center of mass (COM) of the robot is moved away from the center of rotation (COR). BSRs may be classified in different subcategories. Pendulum-based BSRs include a pendulum that bob points in the direction of desired travel. Some BSRs include a smaller wheeled robot inside the sphere or an internal drive unit (IDU). However, these systems may be exposed to slipping between the shell and the IDU. As another subcategory, some BSRs use sliding masses to control the location of the COM. They may be difficult to control in comparison to the two other subcategories described above.

### SUMMARY

In one aspect, there is provided a robot comprising: a sphere-like outer shell defining an inner cavity; an axle unit including an axle connected at its opposed ends to the outer shell, in the inner cavity, and a transmission to transmit a torque to the axle; a pendulum drive unit operatively connected to the axle unit and supported in the outer shell by the axle, the pendulum drive unit having actuators to produce torque, the actuators operatively connected to the transmission of the axle unit; wherein the axle unit and the pendulum drive unit concurrently define a cylindrical joint by which the pendulum drive unit is movable in rotation and translation relative to the axle to tilt and drive the sphere-like outer shell via the actuators.

Further in accordance with the aspect, for example, the actuators are bi-directional motors.

Still further in accordance with the aspect, for example, the bi-directional motors are the same

Still further in accordance with the aspect, for example, a control unit operates the actuators, such that movements of the pendulum drive unit in rotation and in translation relative to the axle resulting from a control of directions of rotation and/or RPM of the bi-directional motors.

Still further in accordance with the aspect, for example, a control unit may operate the actuators, such that movements of the pendulum drive unit in rotation and in translation relative to the axle resulting from a control of directions of rotation of the bi-directional motors.

Still further in accordance with the aspect, for example, the pendulum drive unit includes lead screws receiving a drive from the actuators, the lead screws operatively connected to the transmission of the axle unit to transmit the drive to the axle unit.

Still further in accordance with the aspect, for example, the lead screws are meshed with nuts of the transmission such that the nuts are rotatable relative to and/or translatable along the lead screws as a function of a drive of the actuators.

Still further in accordance with the aspect, for example, the nuts are part of circular transmission members so as to rotate concurrently with the respective circular transmission members.

Still further in accordance with the aspect, for example, the circular transmission members are pulleys, the transmission further including a pulley fixed to the axle, and a belt between the pulleys.

Still further in accordance with the aspect, for example, the pulleys are geared pulleys and the belt is a toothed belt.

Still further in accordance with the aspect, for example, a transmission ratio between the actuators and the axle unit is the same.

Still further in accordance with the aspect, for example, a frame of the pendulum drive unit is slidingly supported to the axle unit by at least one rail.

Still further in accordance with the aspect, for example, the axle unit and the pendulum unit are entirely located in a volume of the inner cavity that is below a top 40% of the inner cavity relative to a vertical diameter of the outer shell.

Still further in accordance with the aspect, for example, a propulsion unit may be mounted to the pendulum drive unit, and having a peg configured to transmit a force to a ground via an opening in the shell to propel the robot upwardly.

Still further in accordance with the aspect, for example, the opening has an elastic membrane supporting a disk, the peg contacting the disk to propel the robot upwardly.

Still further in accordance with the aspect, for example, the propulsion unit has a pair of propulsion devices interconnected to a central member, the peg being part of the central member.

Still further in accordance with the aspect, for example, the propulsion devices of the pair are located on opposite sides of the axle unit.

Still further in accordance with the aspect, for example, the propulsion devices each include a 6-bar mechanism that is spring-biased in flexion to a loaded condition, a release from flexion to extension causing a transmission of the force to the groud.

Still further in accordance with the aspect, for example, a release mechanism is mounted to the central member.

Still further in accordance with the aspect, for example, the outer shell is transparent.

### DESCRIPTION OF THE DRAWINGS

Reference is now made to the accompanying figures in which:

FIGS. 1A and 1B are perspective views of a spherical robot in accordance with the present disclosure, showing a forward motion and steering of the spherical robot, respectively;

FIGS. 2A, 2B and 2C are front views of the spherical robot of the present disclosure, showing different positions of a center of mass of the spherical robot relative to a central plane;

FIG. 3 is a perspective view of an axle unit and a drive unit of the spherical robot of the present disclosure;

FIG. 4 is an exploded view of the assembly of FIG. 3;

FIG. 5 is an assembly view of the spherical robot of FIG. 1;

FIG. 6 is a schematic diagram showing a frame of reference of the spherical robot in support of the kinematics;

FIGS. 7A and 7B are schematic illustration of the robot showing a steering motion as per a geometrical model and per lateral forces and moments;

FIG. 8 is a table providing a legend for the schematic diagram of FIG. 6;

FIG. 9 is a schematic view of joint arrangements of the spherical robot of the present disclosure;

FIG. 10 is a perspective view of the assembly of FIG. 3, with a variant of a propulsion unit, with a frame of a pendulum drive unit removed for clarity;

FIG. 11 is an elevation view of a propulsion device of the propulsion unit of FIG. 10;

FIG. 12 is a perspective view of the propulsion unit of FIG. 10, alone, in an unloaded condition;

FIG. 13 is a perspective view of one of the propulsion devices of the propulsion unit of FIG. 10, in a loaded condition, with the frame of the pendulum drive unit removed for clarity;

FIG. 14 is a schematic view showing kinematics of the propulsion unit; and

FIG. 15 is a view of a propulsion interface in the spherical robot.

### DETAILED DESCRIPTION

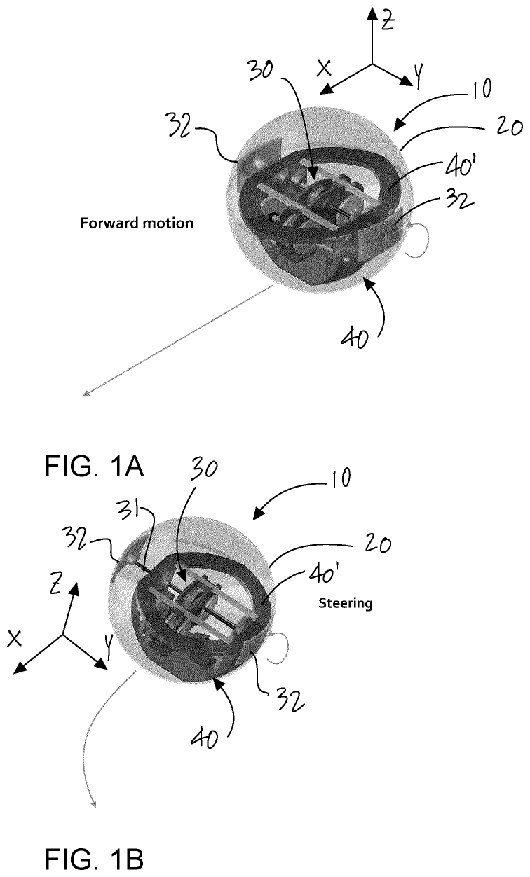

Referring to the drawings and more particularly to FIGS. 1A and 1B, a spherical robot in accordance with the present disclosure is generally shown at 10. References axis X, Y and Z are illustrated with X corresponding to a forward direction and being tied to roll. The Y axis is the lateral axis of the spherical robot 10 and is associated with pitch. The Z axis of the spherical robot 10 is the vertical axis and is associated with yaw.

Referring concurrently to FIGS. 1A, 1B and 5, the spherical robot 10 has a sphere 20 (sphere-like outer shell 20) whose outer surface is the rolling interface of the spherical robot 10 with a ground. The sphere 20 defines an inner cavity in which the components identified as 30 to 80 are inserted. The sphere 20 may be made of a transparent material, though not necessary, and may have a removable segment, such as a cover, to allow access to the inner cavity. For example, the sphere 20 may be separated in two hemispheres. The components inside the sphere 20 may include:
An axle unit 30, rotatingly connected to the sphere 20 and receiving actuation so as to cause a rotation of the sphere 20 both in forward motion and while steering;
A pendulum drive unit 40, also known as pendulum, has the motorization to produce torque by which the sphere 20 will move in the forward motion and/or the steering motion;
A controller unit 60 is the processor acting as intelligence for the spherical robot 10, to control its movement. The controller unit 60 may include any appropriate sensor(s);
A vision system 70 may optionally be provided as a peripheral component for the controller 60 so as to perform vision functions, notably during remote controlling of the spherical robot 10. The vision system 70 may include numerous cameras, a LiDAR, etc;
A propulsion unit 80 may be present to allow the spherical robot 10 to leap, such as vertically or in other directions based on the orientation of the pendulum drive unit 40.

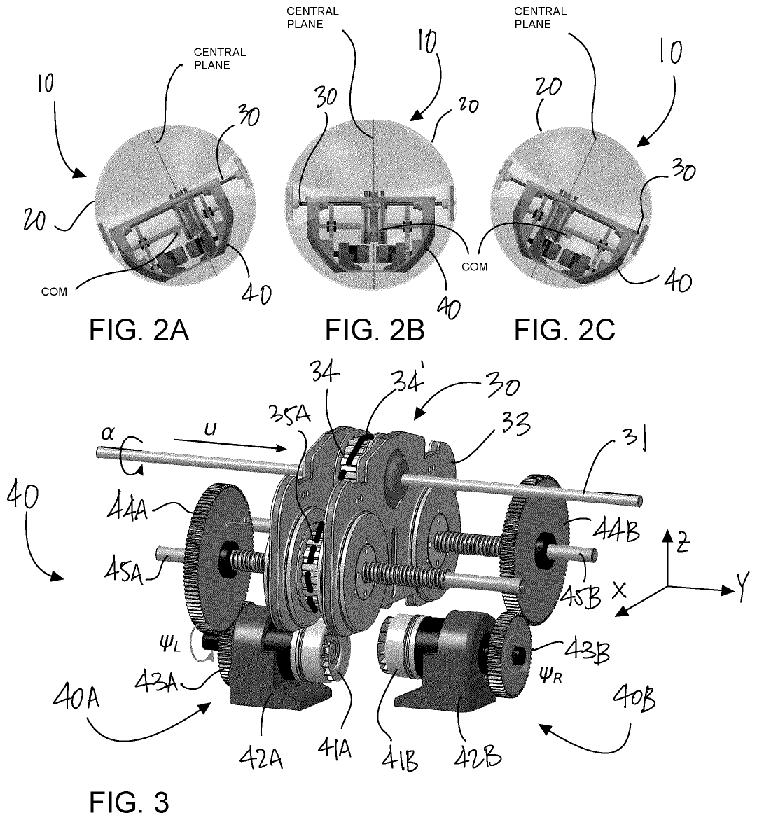

Referring to FIGS. 2A, 2B and 2C, it is observed that the spherical robot 10 may be tilted left or right or may be centered as observed by the location of center of mass relative to a central plane. By moving the center of mass relative to the central plane by the cooperating action of the axle unit 30 and of the pendulum drive unit 40, it is possible to cause a steering of the spherical robot 10. This may occur while the axle unit 30 and the pendulum drive unit 40 impart a rotation to the sphere 20, in a forward or rearward direction. In a variant, the axle unit 30 and the pendulum drive unit 40 are arranged to form a cylindrical joint, in that the pendulum drive unit 40 may rotate and translate relative to the axle unit 30, i.e., move in a translational degree of freedom (DOF) and a rotational (DOF)-two DOFs. The pendulum drive unit 40 supports the actuation to drive the movements in the two DOFs.

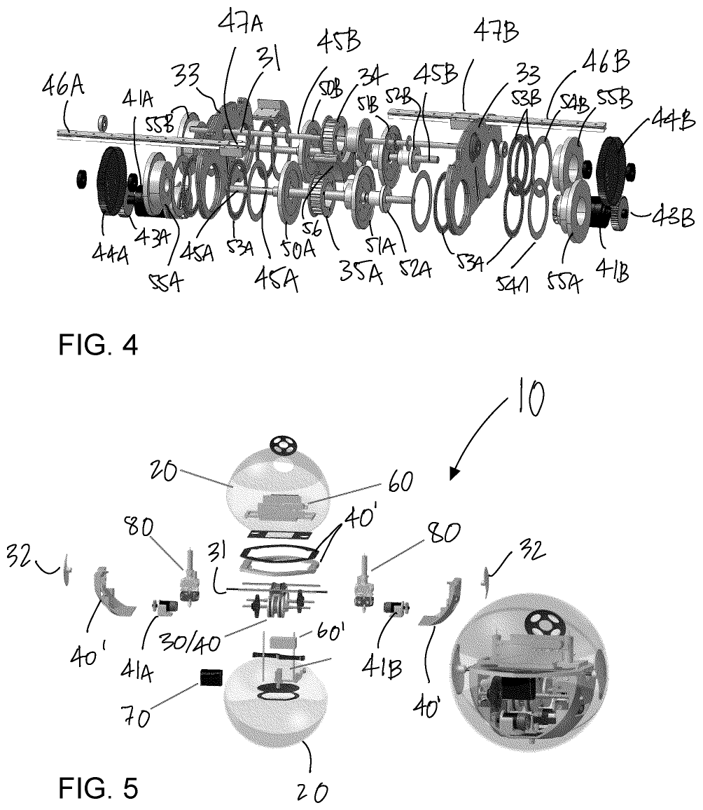

With reference to FIG. 3, the axle unit 30 and the pendulum drive unit 40 are shown as assembled. FIG. 4 shows parts of the axle unit 30 and the pendulum drive unit 40 in an exploded view. The axle unit 30 has axle 31. The axle 31 may also be referred to as a shaft, a rod, among other names. The axle 31 is rigidly connected at its opposed ends to the sphere 20 via the sphere interfaces 32 (FIGS. 1A and 1B). The axle 31 is rigidly connected to the sphere interfaces 32 so as to rotate therewith. The sphere interfaces 32 are fixed to an inner surface or to the wall of the sphere 20. As a consequence, as the axle 31 is rotated by actuation of the pendulum drive unit 40, a rotation will be imparted to the sphere 20 relative to the pendulum drive unit 40, via the axle unit 30. It can be observed that the axle unit 30 passes through a center of the sphere 20, though this may be optional.

Still referring to FIGS. 3 and 4, the axle unit 30 has a frame 33, also known as a chassis, structure, housing, etc. The frame 33 is illustrated as being a pair of plates that are spaced apart to form a gap between them, as one possible construction, with other constructions including a monolithic housing, a single wall, a latticed structure, etc. A transmission member 34, illustrated as a pulley (as an option, other options being gears, geartrain, planetary geartrain), is in the gap of the frame 33, or may be supported by the frame 33 in another other manner. The transmission member 34 is fixedly connected to the axle 31 so as to rotate therewith (e.g., by key/keyway, spline coupling, etc). Stated differently, as the transmission member 34 receives a drive, it will cause a rotation of the axle 31. Moreover, the transmission member 34 is in a fixed position along the axle 31. Stated differently, the frame 33 cannot move along axis Y, i.e., it will remain at the same position along the axle 31. The transmission member 34 is shown as being a pulley but may have other configurations. For example, it may be a gear, a sprocket, among possible other configurations, used for example with a belt 34′, chain, geartrain.

Transmission members 35A and 35B may also provided in the gap of the frame 33 or may be supported by the frame 33 in another other manner. The transmission members 35A and 35B are operatively connected to the transmission member 34 so as to transmit a drive to the transmission member 34, using any appropriate transmission connection (intermeshing, gears, belt, chain, etc). Therefore, the transmission members 35A and 35B are similar in configuration to the transmission member 34, whether it be as a gear, as a pulley, as a sprocket, etc.

There will follow below, with reference to FIG. 4, a description of one contemplated construction for the various components of the axle unit 30 with reference numerals 50 being used. However, in order to better explain the operation of the axle unit 30 relative to the pendulum drive unit 40, the pendulum drive unit 40 will now be described.

As best seen in FIGS. 1A and 1B, the pendulum drive unit 40 has a frame 40′, that may be known as structure, cradle, pendulum, support, housing, etc. The frame 40′ is the structural component of the pendulum drive unit 40 in that it supports its various components. Moreover, the frame 40′ may be tasked with supporting other components of the spherical robot 10, such as the controller 60, the vision system 70 and/or the propulsion unit 80. The frame 40′ may rotate and translate relative to the axle 31 of the axle unit 30. The translation can be observed in FIGS. 2A, 2B and 2C, in which the frame 40′ is shown at various positions along the axle 31, with the location of the frame 40′ having an incidence on the location of the center of mass of the spherical robot 10. It is this translational motion along axis Y that will cause a steering of the spherical robot 10.

The pendulum drive unit 40 may be said to have a pair of drive assemblies, shown as 40A and 40B, respectively associated with the transmission members 35A or 35B. For example, the drive assembly 40A is tasked with providing torque to the transmission member 35A, while the drive assembly 40B is tasked with providing a torque output to the transmission member 35B. Items described from 41A-41B to 45A-45B will be affixed with the letter A or B in the figures based on whether they are part of the drive assemblies 40A or 40B.

The drive assemblies 40A and 40B have motors 41. The motors 41 may for example be electric motors of any appropriate type. For example, the motors are bi-directional, uni-directional, with variable speed output, etc. There are two motors in the pendulum drive unit 40 in the illustrated embodiment, though other motors may be added. In the illustrated embodiment, the two motors 41 may suffice in driving and steering the spherical robot 10. The motors 41 are supported on the frame 40′ by motor supports 42. The motor supports 42 ensure that the motors 41 have a fixed position on the frame 40′, and are one possible securing means, with others including fasteners, attachments, integral construction, etc.

Still referring to FIG. 3, a drive transmission member 43 is provided for each motor 41. The drive transmission member 43 is shown as being a spur gear, though other types of drive transmission members may be used, such as pulleys, sprockets, and other types of gears. The drive transmission members 43 are meshed with driven transmission members 44. The driven transmission members 44 are fixed in position relative to the frame 40′, and are therefore continuously meshed with the respective drive transmission members 43. The driven transmission members 44 are mounted onto shafts 45, which shafts 45 may be rotatably supported by the frame 40′ (e.g., via bearings), as observed from FIGS. 1A, 1B, and rotate while being fixed in rotation relative to the frame 40′. The shafts 45 may also be referred to as worms, or lead screws, as they may have a lead screw portion that is operatingly connected to the transmission members 35. Other devices may be used, such as ball screws. The interconnection between the shafts 45 and the transmission members 35 is such that a 1:1 rotation may be transmitted from the shaft 45 to the respective transmission member 35, and other transmission ratios, including a null transmission of rotation with the rotation from the shaft 45 converted strictly into a translation of the pendulum drive unit 40. Moreover, as described below, the shaft 45 may translate relative to the frame 33 by its meshing with the transmission member 35, meaning that the relative rotation between the transmission member 35 and the shaft 45 may differ from the 1:1 rotation. Rotational speeds differing between the motors 41A and 41B may be controlled to to achieve a translation and concurrent rotation, to achieve steering. The description thereof is provided below along with associated kinematics.

Therefore, as seen in FIG. 4, the frame 40′ may translate relative to the axle unit 30 and this is facilitated by rails 46 of the frame 40′ operatingly connected to sliders 47 of the frame 33 (removed from FIG. 3 for clarity, but optionally received in the slots defined in the top edge of the plates of the frame 33). The sliders 47 are static relative to the axle 31 while the frame 40′ translates by movement of the rails 46 relative to the sliders 47. A reverse arrangement is possible as well (e.g., slider(s) on the frame 40). Moreover, though two sets of rail/slider is shown, it is contemplated to have a single rail and a single slider, or more than two sets, or none at all.

To be able to generate the rolling motion and steer the spherical robot 10, the COM must be able to move in at least two directions relative to the sphere 20. The operation of the spherical robot 10 relies on the control of the position of the COM relative to the central plane, over a virtual right circular cylinder located inside the sphere 20. As a possibility, the center of the sphere 20 is located on the axis of the virtual right circular cylinder, and may corresponds to the axis of the axle 31. To obtain this type of motion of the COM, a cylindrical actuated joint is needed: a differential mechanism with two DoFs, a rotation and a translation, about the same axis, i.e. passing through the center of the sphere 20 in the spherical robot 10.

The motors 41A and 41B may thus be two identical revolute motors used to reduce the complexity of the spherical robot 10. The shafts 45A and 45B may act as two lead screws with the same pitch, one right-hand, the other left-hand, to support the linear motion. The pitches may be different as well. The motors 41 are rigidly attached to the frame 40′, also known as mobile platform or pendulum. Therefore, the motors 41 move inside the sphere 20 by translating about the rolling axis of the sphere 30, coinciding for example with the axle 31. The output of this cylindrical drive generates the rotation required for the sphere 20 to roll, plus the translation needed for the sphere 20 to steer.

As can be seen in FIG. 3, the transmission members 34, 35A and 35B lie in a same plane, e.g., the central plane, the plane passing through a center of the sphere 20. Rotational axes of the transmission members 34, 35A and 35B are normal to the plane. The transmission member 34, i.e., the output of the cylindrical drive, is rigidly attached to the rolling axis of the sphere 20 via the axle 31. The two motors 41 are rigidly attached to the same body, i.e., the frame 40′, the frame 40′ translating as a function of the output of the motors 41.

In the arrangement in which the motors 41 are the same, if both motors 41 turn at the same rate in the same direction, a pure rotation about the axle 31 will be generated, resulting into a forward-only or rearwardly-only motion of the spherical robot 10. If the motors 41 rotate in opposite directions, again with the same rate, a pure translation of the frame 40′ relative to the axle 31 occurs, by the meshing of the transmission members 35 on the shafts 45. The spherical robot 10 then tilts in the plane orthogonal to the rolling motion. This motion is limited, as the translation component of the cylindrical drive is physically bound inside the sphere 20. Any cylindrical motion can be generated by a linear combination of the two foregoing motions.

The controller unit 60 includes one or more processors and a non-transitory computer-readable memory communicatively coupled to the processing unit and comprising computer-readable program instructions executable by the controller unit for controlling the driving and steering of the spherical robot 10. The instructions may be based on kinematics associated with the spherical robot 10.

Joint variables (identified as L for Left and R for right, also respectively corresponding to drive assemblies 40A and 40B) of the cylindrical drive (input) as

$$ψ ≡ {[ \begin{matrix}{ψ}_{L} & {ψ}_{R}\end{matrix} ]}^{T}$$

The output of the cylindrical drive, defined by the variables u and 0, respectively for translation and rotation, is arrayed in vector d. The matrix relation between the output and the input is derived below.

In the following derivations, a model is simplified for clarity. The interactions between rolling motions about the transversal and longitudinal axes are neglected, leading to a decoupled model. Similar decoupled approaches have been applied to wheeled vehicles, unicyle/bicycles and spherical rolling robots. Moreover, considering that the spherical robot 10 may be mostly be used to generate only one of the two motions (translation for steering, rotation for rolling), and that the kinetic energy of the tilting motion may be significantly lower than the one related to the rolling motion during simultaneous rolling and steering, the decoupled model assumption is appropriate.

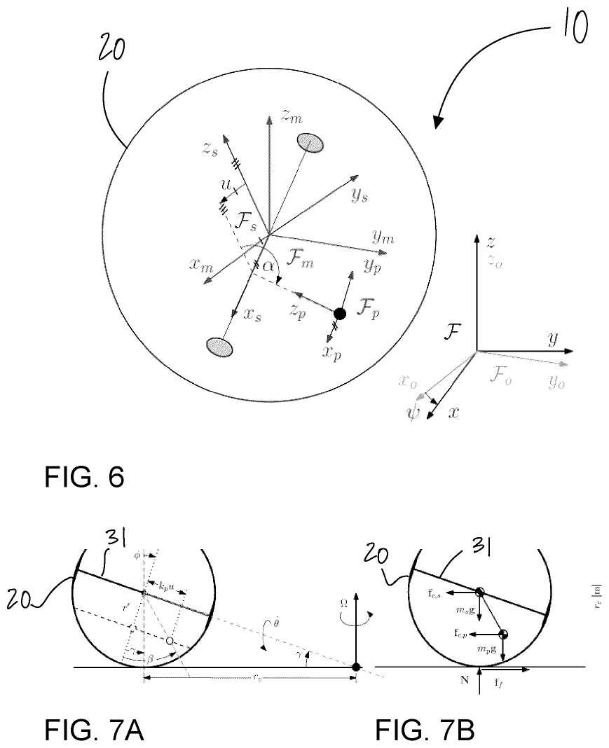

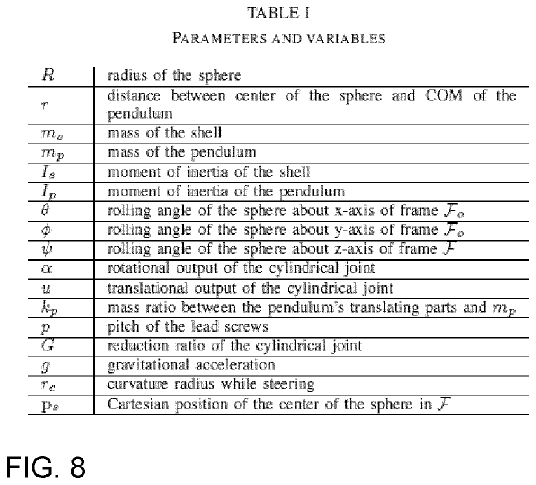

This equations relating the translational and angular displacement of the cylindrical drive to the spherical motion are set forth. With reference to FIG. 6 and the related table of FIG. 8, five frames are used in the following derivation: 1) the inertial reference frame F; 2) the frame Fₒ that is rotated by the angle w about the z-axis of F, where w is the heading of the robot 10; 3) the moving reference frame Fₘ attached to the center of the sphere 20 and only allowed to translate with respect to Fₒ; 4) the frame Fₛ attached to the center of the sphere 20 with its x-axis aligned with the main rotation axis of the spherical robot 10; 5) the frame Fₚ attached to the COM of the pendulum drive unit 40 which is obtained after applying a translation u and a rotation a about the x-axis of Fₛ (which is the axis of the cylindrical joint). While it is possible to use a generic 3-DoF rotation matrix (i.e., defined from an Euler convention) between Fₘ and Fₛ, the decoupled model used herein allows the use of a single rotation angle at a time. For the rolling motion, the x-axes of Fₘ and Fₛ are assumed to be parallel. The rotation angle about this shared axis is therefore θ. For the steering/tilting motion, it is y-axes of Fₘ and Fₛ that are assumed to be parallel, and the angle between their respective x-axes is ϕ. The position of the COM of the cylindrical drive with respect to frame Fₛ is

$${}^{s} {r}_{p} = {[ \begin{matrix}{k}_{p} u & r sin α & - r cos α\end{matrix} ]}^{T} \qquad ( 1 )$$

where r is the distance between the axis of the cylindrical drive and the center of the sphere 20 and kₚ, a scalar, is the ratio between the mass that does not translate (i.e., the axle unit 30) and the total mass of the pendulum, i.e., the pendulum drive unit 40. Variables u and a are, respectively, the translational and rotational output of the cylindrical joint, both illustrated in FIG. 3.

In order to achieve a decoupled model of the dynamics, velocities corresponding to the forward rolling (subscript r) and steering motions (subscript t) of the robot are separated. Since the angular velocity ϕ in FIG. 6 can be neglected because it is significantly lower than the other angular velocities, the kinematics and dynamics analyses are conducted with respect to Fₒ and not F. Therefore, linear and angular velocities of the shell, respectively vs and wₛ, in Fₒ, are

$${r}_{o}^{} {v}_{s} = {[ \begin{matrix}0 & R \dot{θ} & 0\end{matrix} ]}^{T} , {}_{r}^{o} {ω}_{s} = {[ \begin{matrix}\dot{θ} & 0 & 0\end{matrix} ]}^{T} \qquad ( 2 A )$$

$${t}_{o}^{} {v}_{s} = {[ \begin{matrix}R \dot{ϕ} & 0 & 0\end{matrix} ]}^{T} , {}_{t}^{o} {ω}_{s} = {[ \begin{matrix}0 & \dot{ϕ} & 0\end{matrix} ]}^{T} \qquad ( 2 B )$$

where R, e and ϕ are the radius of the sphere 20, its rolling angle and its tilting angle, respectively. Similarly, expression (1) can be split in

$${r}_{s}^{} {r}_{p} = {[ \begin{matrix}0 & r sin α & - r cos α\end{matrix} ]}^{T} \qquad ( 3 a )$$

$${t}_{s}^{} {r}_{p} = {[ \begin{matrix}{k}_{p} u & 0 & - r\end{matrix} ]}^{T} \qquad ( 3 b )$$

The angular velocity of the pendulum, i.e. the cylindrical drive, defined in Fₛ, is

$${r}_{s}^{} {ω}_{p} = {[ \begin{matrix}\dot{α} & 0 & 0\end{matrix} ]}^{T} \qquad ( 4 )$$

and then in Frame Fₘ

$$\begin{matrix}{r}_{m}^{} {ω}_{p} = {r}_{m}^{} {ω}_{s} + {{R}_{x , θ}}_{r}^{s} {ω}_{p} \\ = [ \begin{matrix}0 \\ R \dot{θ} + r cos ( α - θ ) ( \dot{α} - \dot{θ} ) \\ r sin ( α - θ ) ( \dot{α} - \dot{θ} )\end{matrix} ]\end{matrix} \qquad ( 5 a )$$

It should be noted that the translational motion of the cylindrical drive, used to steer the robot 10, does not, by definition, generate any angular velocity, in Fₛ. Thus, ₜ^{s}wₚ is equal to the three-dimensional null vector and ₜ^{m}wₚ is equal to ₗ^{m}wₛ. Finally, the linear velocity of the pendulum can be computed, in frame Fₛ, with

$$\begin{matrix}{r}_{o}^{} {v}_{p} = {r}_{o}^{} {v}_{s} {+}_{r}^{o} {ω}_{p} \times {r}_{o}^{} {r}_{p} \\ = {r}_{o}^{} {v}_{s} {+}_{r}^{o} {ω}_{p} \times ( {{R}_{x , θ}}_{r}^{s} {r}_{p} ) \\ = [ \begin{matrix}0 \\ R \dot{θ} + r cos ( α - θ ) ( \dot{α} - \dot{θ} ) \\ r sin ( α - θ ) ( \dot{α} - \dot{θ} )\end{matrix} ]\end{matrix} \qquad ( 6 a )$$

$$and$$

$$\begin{matrix}{t}_{o}^{} {v}_{p} = {t}_{o}^{} {v}_{s} {+}_{t}^{o} {ω}_{p / s} + {t}_{o}^{} {v}_{p} {-}_{t}^{o} {ω}_{p} {\times }_{t}^{o} {r}_{p} \\ = {t}_{o}^{} {v}_{s} + {{R}_{y , ϕ}}_{t}^{s} {v}_{p / s} + {}_{t}^{o} {ω}_{p} \times ( {{R}_{y , ϕ}}_{t}^{s} {r}_{p} ) \\ = [ \begin{matrix}R \dot{ϕ} + {k}_{p} u sin ϕ \dot{ϕ} - \dot{ϕ} r cos ϕ + \dot{u} cos ϕ \\ 0 \\ - {k}_{p} u \dot{ϕ} cos ϕ + \dot{ϕ} r sin ϕ - \dot{u} sin ϕ\end{matrix} ]\end{matrix} \qquad ( 7 a )$$

Where R_{y,ϕ} is the rotation matrix between frames Fₛ and Fₘ with respect to the steering/tilting motion.

As mentioned above, the transmission members 34, 35A and 35B can only rotate about their axis, but cannot translate inside the sphere 20. Vector d, the output of the cylindrical joint, is mapped by the 2×2 Jacobian matrix Jₚ into the joint variables Ψ:

$$ψ = {J}_{p} d \qquad ( 8 a )$$

$$with$$

$$\begin{matrix}{J}_{p} ≡ \frac{1}{p} [ \begin{matrix}2 π & p G \\ - 2 π & p G\end{matrix} ] . \\ d = {[ \begin{matrix}u & α\end{matrix} ]}^{T}\end{matrix} \qquad ( 8 b )$$

where u and a, as mentioned above, are the translational and rotational output of the cylindrical joint, G and p are, respectively, the gear-reduction ratio of the assembly of the axle unit 30 and pendulum drive unit 40 and the pitch of the lead screws or worm portion of the shafts 45A, 45B (taken as the same for symmetry). An homogeneous Jacobian matrix is obtained by converting the cylindrical drive output array d into a distance with units of length, x=Ra, and the lateral displacement of the COM (unchanged), u, i.e.

$$[ \begin{matrix}u \\ α\end{matrix} ] = [ \begin{matrix}1 & 0 \\ 0 & 1 / R\end{matrix} ] [ \begin{matrix}u \\ x\end{matrix} ] \qquad ( 9 )$$

$$therefore ,$$

$$\begin{matrix}ψ = {J}_{s} x , x ≡ [ \begin{matrix}u \\ x\end{matrix} ] , \\ {J}_{s} ≡ \frac{1}{p} [ \begin{matrix}2 π & p G / R \\ - 2 π & p G / R\end{matrix} ]\end{matrix} \qquad ( 10 )$$

The spherical robot 10 has two independent control variables: the rotation and the translation of the pendulum drive unit 40, corresponding, respectively to the rolling and the steering motion of the sphere 20.

With the kinematics of the spherical robot 10, its decoupled dynamics model can be derive. The Lagrangian approach is chosen to obtain the equations of motion. The decoupled expressions of the kinetic energy are

$${{{{K}_{r} = \frac{1}{2} ( {m}_{s} {‖}_{r}^{o} {v}_{s} {‖}^{2} + {}_{r} {I}_{s} {‖}_{r}^{o} {ω}_{s} ‖}^{2} + {m}_{p} {‖}_{r}^{o} {v}_{p} ‖}^{2} + {}_{r} {I}_{p} {‖}_{r}^{o} {ω}_{p} ‖}^{2} ) \qquad ( 11 A )$$

$${K}_{t} = \frac{1}{2} ( {m}_{s} {‖}_{t}^{o} {v}_{s} {‖}^{2} + ( {}_{t} {I}_{s} + {}_{t} {I}_{p} ) {‖}_{t}^{o} {ω}_{s} {‖}^{2} + {m}_{p} {‖}_{t}^{o} {v}_{p} {‖}^{2} ) \qquad ( 11 B )$$

where ᵣlₛ and lₚ are, respectively, the moment of inertia of the sphere 20 and the pendulum drive unit 40 with respect to the plane parallel to the transmission members 34, 35A, 35B and passing through the center of the sphere 20.

With the COM of the sphere 20 located at the geometrical center of the sphere 20 (no effect), the decoupled expression of the potential energy are

$${}_{r} {E}_{p} = - {m}_{p} gr cos ( α - θ ) \qquad ( 12 A )$$

$${}_{t} {E}_{p} = {m}_{p} {gk}_{p} u sin ϕ - r cos ϕ \qquad ( 12 B )$$

From Eₖ and Eₚ, two decoupled Langragian functions are obtained: Lᵣ with only rotational terms about the transversal axis, and Lᵢ about the longitudinal axis.

For translation along the y-axis of frame Fₘ, i.e. the forward rolling motion, the Euler-Lagrangian equations are therefore

$$\begin{matrix}\frac{d}{dt} ( \frac{\partial {L}_{r}}{\partial \dot{θ}} ) - \frac{\partial {L}_{r}}{\partial θ} = {τ}_{θ} . \\ \frac{d}{dt} ( \frac{\partial {L}_{r}}{\partial \dot{α}} ) - \frac{\partial {L}_{r}}{\partial α} = {τ}_{α}\end{matrix} \qquad ( 13 )$$

It should be noted here that T_{θ}=Tₐ=T is the torque component of the output of the cylindrical joint. When a torque is applied on the sphere 20, a reaction torque to the pendulum axis occurs in the opposite direction. For translation along the x-axis of frame Fₘ, i.e. the tilting/steering motion, the Euler-Lagrangian equations are

$$\begin{matrix}\frac{d}{dt} ( \frac{\partial {L}_{t}}{\partial \dot{ϕ}} ) - \frac{\partial {L}_{t}}{\partial ϕ} = {τ}_{ϕ} . \\ \frac{d}{dt} ( \frac{\partial {L}_{t}}{\partial \dot{u}} ) - \frac{\partial {L}_{t}}{\partial u} = f\end{matrix} \qquad ( 14 )$$

Here, the force f is the force output of the cylindrical joint, and To is the torque applied on the sphere 20, which can be computed with the following expression:

$${T}_{ϕ} = f R sin ϕ \qquad ( 15 )$$

The last four equations can be written in matrix form: with

$$M ( q ( t ) ) \ddot{q} ( t ) + V ( q ( t ) . \dot{q} ( t ) ) = f ( t ) \qquad ( 16 a )$$

$$q = {[ \begin{matrix}θ & a & o & u\end{matrix} ]}^{T} . f = [ \begin{matrix}τ & τ & fR sin o & {f ]}^{T}\end{matrix} \qquad ( 16 b )$$

where M is the inertia tensor and V is an array containing the other wrenches acting on the system, such as internal and external friction forces and the cross-influence of the velocity components (alike coriolis).

The distance between the cylindrical drive axis and the center of the sphere 20 is r′, which, as a function of the pendulum's angle, can be expressed as

$${r}^{′} = r cos ( α + θ ) \qquad ( 17 )$$

Moreover, regardless of the steering mechanism chosen, the angular velocity of the spherical robot 10 about the vertical axis of the reference frame F is

$$Ω = - R \dot{θ} / {r}_{c} \qquad ( 18 )$$

where R, θ and r_{c} are, respectively, the radius of the sphere 20, the rolling angular velocity of the sphere 20 and the radius of curvature while steering. Therefore, since none of the first two are affected by the steering mechanism, tilting and cylindrical mechanisms must be compared over how the radius of curvature r_{c} is generated. For the cylindrical pendulum, the magnitude of the friction force between the ground and the sphere 20 is computed with the following expression:

$$\begin{matrix}‖ {f}_{f} ‖ = ‖ {f}_{c , s} ‖ + ‖ {f}_{c , p} ‖ \\ = {m}_{s} {r}_{c} {Ω}^{2} + {m}_{p} ( {r}_{c} + {k}_{p} u cos ϕ ) {Ω}^{2} \\ \approx ( {m}_{s} + {m}_{p} ) {r}_{c} {Ω}^{2}\end{matrix} \qquad ( 19 )$$

where f_{c,i}, i={s,p} are the centrifugal forces acting on the sphere 20 and the pendulum and Q is the angular velocity of the sphere 20 about the z-axis in F. As can be seen, the translation component of the cylindrical pendulum is neglected, as T_{c} is assumed significantly larger than u. Then, the magnitude of the torque acting about the transversal axis of the sphere 20, i.e. the y-axis of frame Fₛ, is computed with

$$\begin{matrix}{T}_{y} = - R ‖ {f}_{f} ‖ - {m}_{p} g ( {r}^{′} sin ϕ + {k}_{p} u cos ϕ ) + \\ ‖ {f}_{c , p} ‖ ( {r}^{′} cos ϕ - {k}_{p} u sin ϕ ) \\ \approx - R ( {m}_{s} + {m}_{p} ) {r}_{c} {Ω}^{2} - {m}_{p} g ( {r}^{′} sin ϕ + {k}_{p} u cos ϕ ) + \\ {m}_{p} {r}_{c} {Ω}^{2} ( {r}^{′} cos ϕ - {k}_{p} u sin ϕ )\end{matrix} \qquad ( 20 )$$

Knowing that the angular velocity of the sphere 20, in Fₘ, is

$$ω = {[ \begin{matrix}- \dot{θ} cos ϕ & - \dot{ϕ} & Ω - \dot{θ} sin ϕ\end{matrix} ]}^{T} \qquad ( 21 )$$

and that its angular momentum is defined as (the moment of inertia of the sphere 20 is assumed to be the same regardless of the plane, i.e. ᵣlₛ=ₜlₛ=lₛ)

$$L = {I}_{s} ω = {[ \begin{matrix}- {I}_{s} \dot{θ} cos ϕ & - {I}_{s} \dot{ϕ} & {I}_{s} ( Ω - \dot{θ} sin ϕ )\end{matrix} ]}^{T} \qquad ( 22 )$$

then the total torque applied on the sphere 20, which is the time derivative of L, can also be obtained as L=Ω×L since the sphere 20 is undergoing uniform circular motion, i.e.

$$T = {[ \begin{matrix}{I}_{s} Ω \dot{ϕ} & - {I}_{s} Ω \dot{θ} cos ϕ & 0\end{matrix} ]}^{T} \qquad ( 23 )$$

Ω is the angular velocity vector defining the uniform circular motion, i.e. Ω=[0 0 Ω]^{T} and should not be confused with w. Therefore, the second component of T must be equal to T_{y}. After some simplifications and using a small-angle assumption for ϕ, there is achieved:

$${r}_{c , cyl} \approx \frac{- {m}_{p} {r}^{′} {R}^{2} {\dot{θ}}^{2} + {I}_{s} R {\dot{θ}}^{2} + {R}^{3} ( {m}_{s} + {m}_{p} ) {\dot{θ}}^{2}}{{k}_{p} {um}_{p} g} \qquad ( 24 )$$

Using the same set of parameters (mass, moment of intertia, location of the COM, etc.), the spherical robot 10 may be compared with a more conventional 2-DoF tilting mechanism. A pure rolling motion will result in the same behavior, since they are both based on the same principle. However, the steering mechanisms differ: the spherical robot 10 generates a translation, while the more conventional 2-DoF tilting mechanism generates a rotation. In both cases, steering is a function of the deviation of the COM with respect to the center plane of the sphere 20, as shown in FIGS. 7A and 7B. The original location of the COM is assumed to be the same for both steering systems.

The curvature radius r_{c} is not computed the same way depending on the steering mechanism implemented. An equivalent expression exists for a 2-DoF tilting pendulum (again assuming that ϕ remains small), i.e.

$${r}_{c , tilt} \approx \frac{R {\dot{θ}}^{2} ( {I}_{s} - {m}_{p} {Rr}^{′} cos β ) + {R}^{3} {\dot{θ}}^{2} ( {m}_{s} + {m}_{p} )}{{m}_{p} g {r}^{′} sin β} \qquad ( 25 )$$

It can therefore be seen that both equations 24 and 25 have a similar structure, i.e.

$${r}_{c} \approx C ( A - B ζ ) / η \qquad ( 26 )$$

where

$$A = {I}_{s} + {R}^{2} ( {m}_{s} + {m}_{p} ) , B = {m}_{p} {r}^{′} R , C = \frac{R {\dot{θ}}^{2}}{{m}_{p} g} \qquad ( 27 a )$$

$${ζ}_{cyl} = 1 , {ζ}_{tilt} = cos β , {η}_{cyl} = {k}_{p} u , {η}_{tilt} = {r}^{′} sin β \qquad ( 27 b )$$

Hence, the curvature radius is a function of the rolling angular velocity θ and u for the cylindrical mechanism or β for the tilting mechanism. The slower the sphere 20 rolls, the smaller is the curvature radius.

Without the torque from the motors 41, the cylindrical drive is only statically balanced in three positions: the central position u=0 and when it is in contact with its mechanical limits (u=Uₘᵢₙ <0 or u=Uₘₐₓ>0). Indeed, the distance between the center of the sphere 20 and the COM of the pendulum increases if |u|>0. The conventional tilting mechanism, however, is stable at every value of β. In practice, considering friction and the high gear-reduction ratio of the cylindrical drive, a stable position exists for any value of u in a real-life scenario. This observation leads to an advantage: it reduces the torque needed at the motors 41 to tilt the robot 10 with a cylindrical drive.

There are, however, other advantages for the cylindrical pendulum of the spherical robot 10 over a tilting mechanism. For instance, the former may leave the upper part of the sphere 20 mostly empty (e.g., at least 40% of a diameter along the Z axis), which can be useful to host a payload like the controller unit 60 and associated components (PCB, battery 60′, inertial sensors, etc), the vision system 70 which may include a LIDAR, and the propulsion unit 80. In the illustratement embodiment, the controller unit 60 may include a stereo camera.

Moreover, a conventional tilting mechanism may require more internal workspace (empty space for the pendulum motion) than that required by the assembly of axle unit 30 and pendulum drive unit 40. It should also be noted that, as illustrated in FIG. 7A, the COM of the pendulum drive unit 40 is further away from the center of the sphere 20 with a cylindrical mechanism while steering. Therefore, the maximum torque output of the pendulum may be greater.

Referring now to FIG. 4, an exemplary construction of the axle unit 30 and pendulum drive unit 40 is shown, just as an example. The illustrated construction is one among others. The transmission members 35A and 35B of the axle unit 30 are shown in accordance with this one possible construction. Again, letters A and B will be affixed to the various components in the 50s and the figures and may correspond to L and R in the kinematics derived above. The present disclosure makes reference concurrently to disk 50, for example as a combined description for disks 50A and 50B, that are respectively associated with transmission member 35A and 35B in FIG. 4.

Disk 50 and disk 51, having a trunnion, support thereon the transmission member 35, shown as being a geared pulley for toothed belt. As mentioned above, the transmission member 35 may be of other type. In an embodiment, the transmission member 35, disk 50 and disk 51 with trunnion rotate concurrently. Bushing 52 is passed into the combination of the transmission member 35, disks 50 and 51, and may also be referred to as a nut. The bushing 52 is meshed with the threaded portion (i.e., lead screw, threading, etc) of the shaft 45. In the illustrated embodiment, it is therefore the bushing 52 that has the necessary threading to move in translation along the screw shaft 45 and/or transmit torque from the shaft 45 to the transmission member 35. Hence, the bushing 52 is an integrally connected to the transmission member 35, such as via disks 50 and 51, but this is merely an option, with the transmission member 35 for example being threaded internally being another option.

Bearings 53 (e.g., needle bearing, roller bearing) and washers 54 may be the interface between the disks 50, 51 and the frame 33 so as to allow the rotation of the assembly of transmission member 35, disk 50 and disk 51. Rotational supports 55 may be provided on the exterior of the frame 33 and act as rotational supports allowing the rotation of the transmission member 35, disk 50, disk 51 and bushing 52. A spacer 56 may optionally be present between the transmission members 34, 35A and 35B as part of the frame 33, to rigidify the assembly. The transmission members 35, disk 50,51, bushing 52, and rotational supports from a rigid assembly precluding any relative movement between these components.

Equipped with an actuated cylindrical joint acting as a pendulum with two degrees-of-freedom (Dof), the spherical robot 10 has a continuous differential transmission to allow simultaneous rolling and steering. Thus, the spherical robot 10 may be said to have robust internal mechanism, with optimized mass allocation (no dead weight), a really low center of mass and an upper half of the sphere 20 free of the axle unit 30 and pendulum drive unit 40, for housing a payload. The 2-degrees-of-freedom (DoF) output of the cylindrical joint can be computed by the controller unit 60 with a linear combination of the motors' angular position and the curvature radius while steering is inversely proportional to the linear displacement of the cylindrical joint, to simplify the control of the spherical robot 10.

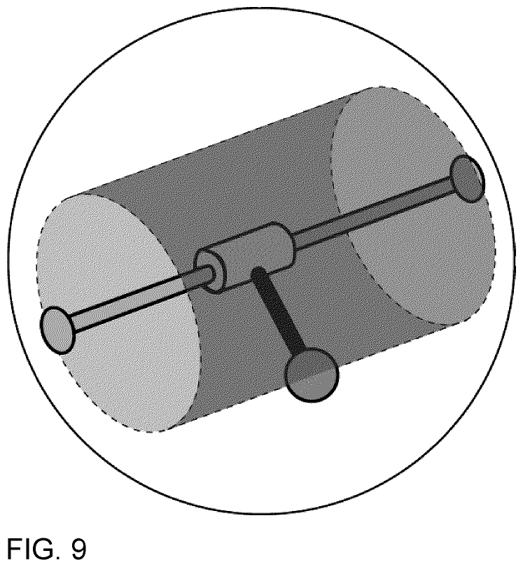

Referring to FIG. 9, a schematic version of the spherical robot is shown. The proposed barycentric spherical robot rolls on the ground with a motion induced by a displacement of its center-of-mass (COM), which is done by an actuated pendulum. To be able to steer the sphere as well, and not only roll forward and backward in one single direction, two controlled DoFs are required. In the embodiments described herein, the COM can be displaced over an imaginary cylinder inside the sphere, as shown highlighted in FIG. 9. If the cylindrical joint is not located at the center of the sphere, i.e. it underwent a translation from its original position, the spherical robot will tilt on one side. Then, with a simple rotation of the pendulum about the axis of the cylindrical joint, the robot will roll and steer at the same time. Because of the nature of the cylindrical joint, namely independent translation and rotation, the steering angle can be changed as the spherical robot rolls. The cylindrical actuated joint is therefore a differential transmission.

In some circumstances, it is desired to have the propulsion unit 80 in the spherical robot 10, or in any other spherical robot, though the propulsion unit 80 may be optional. For example, when some obstacles are present, the propulsion unit 80 may be used to enable the robot 10 to leap vertically. In parallel, the pendulum unit 40 may orient itself for the center of mass to be offset from a frontal plane of the robot 10, such that a leap may result in a directional movement. The frontal plane of the robot 10 may be described as including the rotational axis of the axle 31 and the gravity vector (i.e., the rotational axis and the gravity vector lie in the frontal plane of the spherical robot 10).

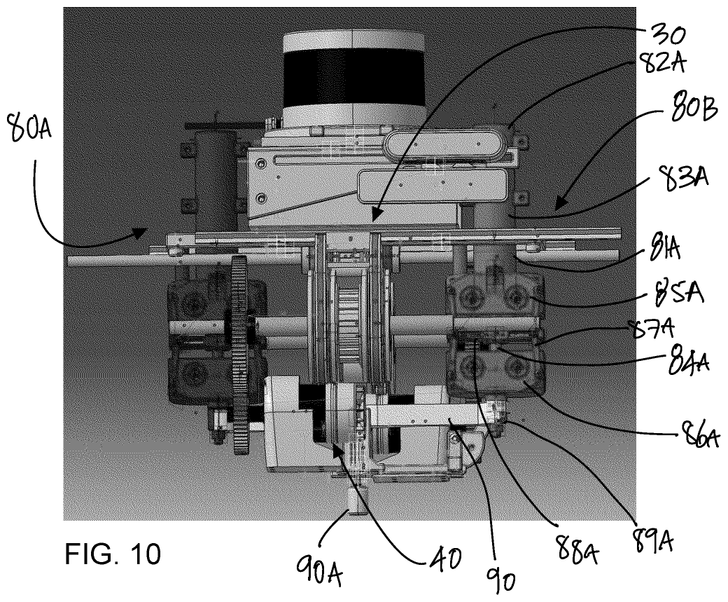

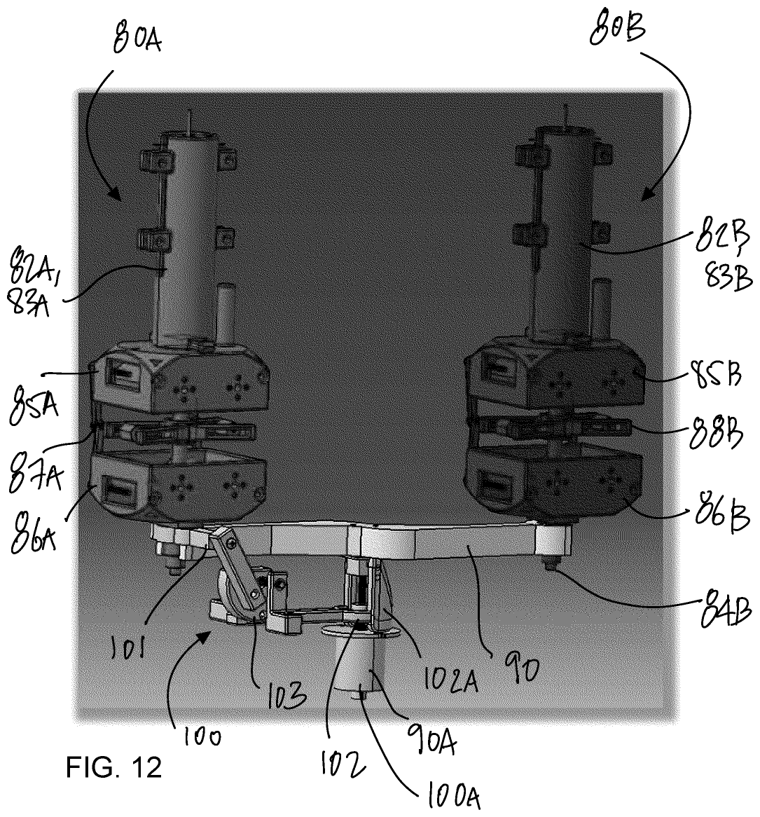

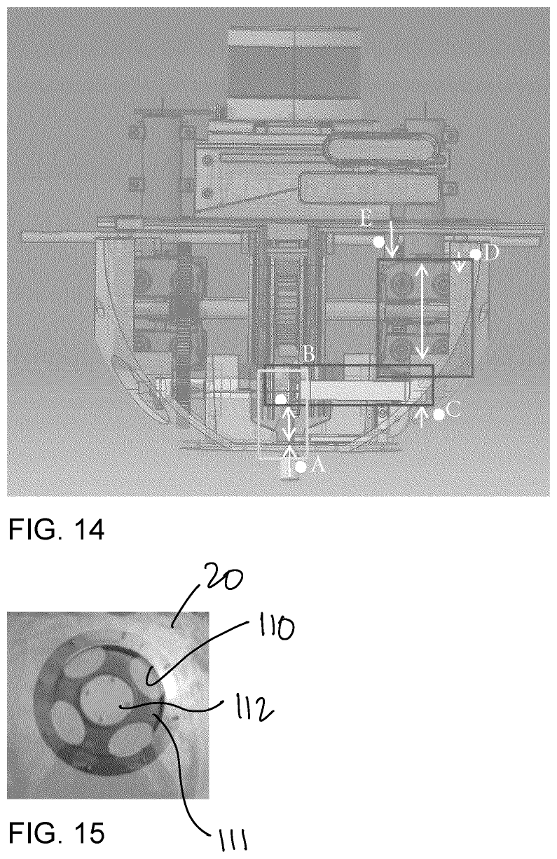

In a variant, in order to distribute the weight uniformly and increase the output, the propulsion unit 80 may have a pair of propulsion devices, shown as 80A and 80B, on either side of the axle unit 30. A single propulsion device 80A or 80B could be present, as shown in FIGS. 10 and 12. Items described from 81A-81B to 89A-89B in FIGS. 10 to 14 will be affixed with the letter A or B in the figures based on whether they are part of the propulsion devices 80A or 80B, and may be referred to concurrently with letters A or B affixed to them. The propulsion devices 80A and 80B may be mounted to the frame 40′ of the pendulum unit 40, removed from FIGS. 10 and 12 for clarity. In a variant, the propulsion devices 80A and 80B are located between the shafts 45, such as in a volume adjacent to the transmission members 44. Other locations are possible.

Each of the propulsion device 80A,80B has a frame 81, or other like support, including hardware components to be mounted to the frame 40′. In a variant, the frame 81 is part of the frame 40′. Motors 82 may be at a top end of the propulsion device 80A,80B. In a variant, the motors 82 are electric motors, and may be unidirectional. As an option, the motors 82 are oriented in such a way that rotational axes of their shafts are aligned with a direction of movement of the output end of the propulsion devices 80A, 80B, but this is optional. The motors 82 may be controlled by the control unit 50. The motors 82 are tasked with loading the propulsion devices 80A,80B, for the propulsion devices 80A,80B to then discharge loaded forces into a downward movement that is transmitted to the ground to propel the spherical robot 10 upwardly. The motors 82 are actuated to rotate the lead screw 84 (also known as screw, bolt, etc). Optionally, a gear box 83 (83A, 83B) may be present. For example, the gear boxes 83, or other types of reduction systems, are used to increase a torque from the output of the motors 82.

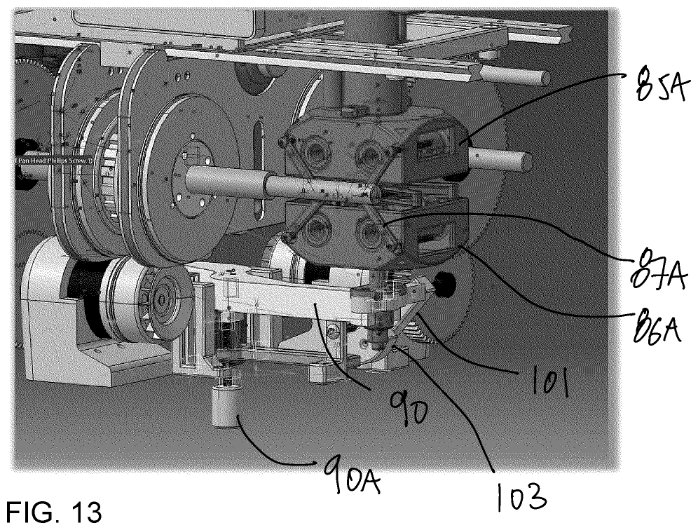

The propulsion devices 80A,80B may each be regarded as 6-bar mechanism that is loaded to a compressed state, referred to as a loaded condition, to biasingly return to an unloaded state or condition and in the process propel the robot 10 upwardly. As part of the 6-bar mechanism, a top link 85 may be connected to the frame 81, or may be part of the frame 81. If they are separate components, the frame 81 and the top link 85 are rigidly connected. The top link 85 could also be connected directly to the frame 40′. In a variant, the top link 85 may be a receptable, by which the propulsion device 80A, 80B may be connected to other components, such as the frame 40′. A bottom link 86 is below the top link 85, the bottom link 86 being the output end of the 6-bar mechanism, as it is the bottom link 86 that moves relative to the frame 40′ to cause a leaping action. The bottom link 86 is operatively connected to the top link 85 by at least a pair of articulated arms 87. The articulated arms 87 are defined by two links pivotally connected to one another, ends of the articulated arms 87 being pivotally connected to the top link 85 and the bottom link 86 by pivots. To reinforce the propulsion devices 80A,80B, there may be four such articular arms 87, though optional. However, the symmetry in the arrangement is such that it behaves as a 6-bar mechanism, with the 6-bar mechanism being defined by two of the articulated arms 87 connected in parallel to the top link 85 and the bottom link 86. Moreover, guides 88 are optionally present and receive therein a follower that is coaxially on the pivots between the links of the articulated arms 87. The guides 88 help to delimit movement of the articulated arms 87, such as limiting their movement to a full extension. The guides 88 may be mounted to a sleeve on the lead screw 84. The guides 88 may also be arranged for the joints between links in the articulated arms 87 to move toward one another when the articulated arms 87 are flexed toward the loaded condition shown in FIG. 13.

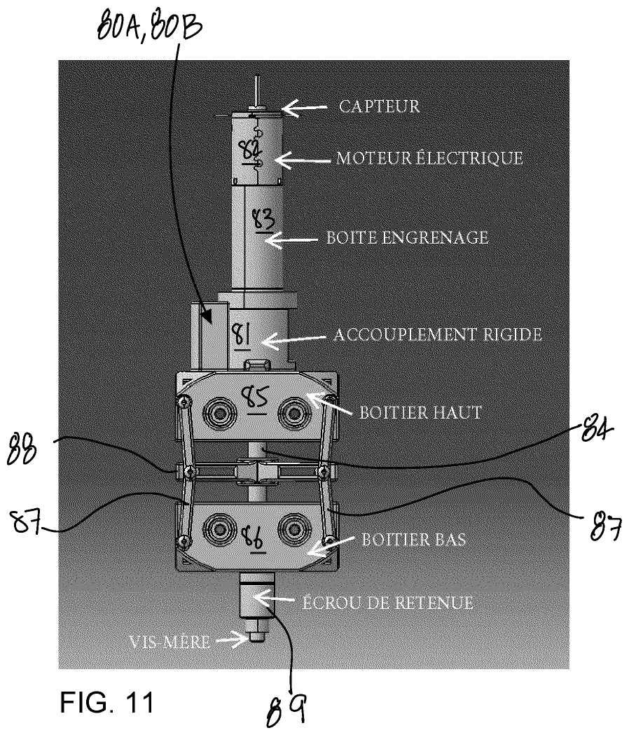

The rotational joints interconnecting the links of the articulated arms 87 may be spring loaded, such that the articulated arms 87 are biased to full extension, as shown in FIG. 11. The springs (e.g., torsion springs) may also be located between the articulated arms 87 and the top link 85 and/or the bottom link 86. Other types of springs may be used, such as coil springs in the guides 88. In a variant, the springs are in the receptacle of the top link 85 and/or of the bottom link 86 (which may feature spring mounts for torsion springs). The springs may be rigidly connected to their respective top link 85 and/or bottom 86 which makes them compress as the articulated arms 87 move inwards toward the loaded condition.

A nut 89 is threadingly engaged to the lead screw 84. The nut 89 may be abutted against the 6-bar mechanism, e.g., bottom link 86, in such a way that it cannot rotate once against the bottom link 86. Therefore, a rotation of the lead screw 84 results in a translation of the nut 89 along the lead screw 84. In a variant, the lead screw 84 rotates in a single direction, to move the nut 89 upwardly. In doing so, the bottom link 86 moves upwardly and flexes the articulated arms 87, against the action of the springs. As a result, the propulsion devices 80A,80B are loaded, in that the bottom link 86 has compressed the biasing member in the articulated arms 87. FIG. 13 shows in the loaded condition, whereas FIG. 11 shows the unloaded, at rest, condition. The nut 89 may then be disengaged from the bottom link 86, for example by a rotation of the lead screw 84 in an opposite direction. An abutment is present to ensure that the nut 89 is prevented from rotating on the lead screw 84. Therefore, the nut 89 no longer retains the bottom link 86, and is not an obstacle against the sudden downward movement of the bottom link 86 during the leaping action.

A central member 90 interconnects the propulsion devices 80A, 80B, such that the bottom links 86A,86B move concurrently. Consequently, the control unit 50 operates the motors 82 synchroneously to load the propulsion devices 80A,80B concurrently. The central member 90 may have a central peg 90A (a.k.a., piston), being at a bottom end of the propulsion unit 80. The central peg 90A is the part of the propulsion unit 80 that contacts the ground in the leaping action (or contacts a member of the sphere that is between the peg 90A and the ground), to transmit the release force from the propulsion unit 80 to the ground. The release force occurs when the 6-bar mechanisms are released from the loaded condition, with the loaded articulated arms 87 rapidly moving to their extension as a response of the biasing action of the springs on the articulated arms 87, and with the nuts 89A, 89B moved out of the way.

Referring to FIG. 12, a release mechanism 100 may be present to hold the propulsion devices 80A,80B in their loaded condition, by way of a trigger 101. The release mechanism 100 may release the trigger 101 to initiate the leaping movement. The release mechanism 100 is connected to the frame 40′ and may also be slidingly mounted to the peg 90A, via a hub 102. The peg 90A may include a motor 100A that is part of the release mechanism 100. The motor 100A is actuated to assist in raising the central member 90, via a nut. Finger 102A pivots to assist in holding the central member 90 loaded, and the nut may then be lowered by rotation of the motor 100A in the opposite direction. As observed, the trigger 101 may be a pivoting arm that has an end in contact with one of the two bottom links 86A or 86B, to oppose a mechanical force against the bottom link 86A or 86B, keeping the propulsion devices 80A,80B in the loaded condition. The trigger 101 may be mounted to a cam portion 103, which cam portion 103 is released from engagement (e.g., via any appropriate detent) to allow the arm of the trigger 101 to swing away, dislodge the finger 102A and thus let the propulsion devices 80A,80B move to the unloaded condition. This release mechanism 100 is one among others that can be used. For example, a simple retaining piston could be used, etc.

Referring to FIG. 15, an opening 110 may be defined in the sphere 20, for the peg 90A to transmit its force to the ground. A flexible membrane 111 may be used to support an interface disk 112, to seal off the sphere 20 in spite of the opening 110. In a variant, there is only the flexible membrane 111, and no disk 112. In another variant, there is nothing in the opening 110.

During use, the pendulum drive unit 40 may be operated to align the peg 90A with the opening 110, for the peg 90A to transmit its force to an environment of the spherical robot 10 via the opening 110.

In a variant, the spherical robot 10 may be described as having a sphere-like outer shell defining an inner cavity. An axle unit including an axle may be connected at its opposed ends to the outer shell, in the inner cavity, and a transmission to transmit a torque to the axle. A pendulum drive unit is operatively connected to the axle unit and supported in the outer shell by the axle, the pendulum drive unit having actuators to produce torque, the actuators operatively connected to the transmission of the axle unit. The axle unit and the pendulum drive unit concurrently define a cylindrical joint by which the pendulum drive unit is movable in rotation and translation relative to the axle to tilt and drive the sphere-like outer shell via the actuators. The expression “cylindrical joint” may refer to the two degrees of freedom (DOF) by which the pendulum drive unit may move relative to the axle unit, i.e., a translational DOF and a rotational DOF. A control unit operates the actuators, such that movements of the pendulum drive unit in rotation and in translation relative to the axle result from a control of directions of rotation the bi-directional motors (e.g., such as if the motors are the same and output the same revolutions per minute (RPM) or other speed related output such as angular speed). A control unit may operate the actuators, such that movements of the pendulum drive unit in rotation and in translation relative to the axle resulting from a control of directions of rotation and/or RPM of the bi-directional motors. The pendulum drive unit may include lead screws receiving a drive from the actuators, the lead screws operatively connected to the transmission of the axle unit to transmit the drive to the axle unit. The lead screws are meshed with nuts of the transmission such that the nuts are rotatable relative to and/or translatable along the lead screws as a function of a drive of the actuators. The nuts may be part of circular transmission members (gear, geared pulley, pulley, chain ring or sprocket, etc) so as to rotate concurrently with the respective circular transmission members. Thus in a variant, the circular transmission members are pulleys, the transmission further including a pulley fixed to the axle, and a belt between the pulleys. The axle unit and the pendulum drive unit are entirely located in a volume of the inner cavity that is below a top 40% of the inner cavity relative to a vertical diameter of the outer shell. This can be described a frustum of a sphere, or frusto sphere, who's height is equal to at least 40% of the diameter of the sphere 20. It is possible to have a space that is between 25%-40% of the diameter. The space may be filled by components mounted to the axle unit 30 and/or the pendulum drive unit 40, which components may be peripherals (e.g., vision system). However, in a variant, the drive components that enable movement of the axle unit 30 and/or the pendulum drive unit 40 leave the top 25%-40% of the spherical robot 10 empty.

A propulsion unit may be mounted to the pendulum drive unit in the spherical robort 10 or in any other spherical robot. The propulsion unit has a peg or any other output (e.g., post, piston, leg, etc) configured to transmit a force to a ground via an opening in the shell to propel the robot upwardly. The opening may have an elastic membrane supporting a disk, the peg contacting the disk to propel the robot upwardly. The propulsion unit may have a pair of propulsion devices interconnected to a central member, the peg being part of the central member. The propulsion devices of the pair may be located on opposite sides of the axle unit. In a variant, the propulsion devices each include a 6-bar mechanism that is spring-biased in flexion to a loaded condition, a release from flexion to extension causing a transmission of the force to the groud. A release mechanism is mounted to the central member.

The above description is meant to be exemplary only, and one skilled in the art will recognize that changes may be made to the embodiments described without departing from the scope of the invention disclosed. The expressions sphere and spherical are used herein to describe the sphere-like shape of the outer shell of the robot 10. Sphere, spherical and sphere-like shape are not intended to cover solely a perfectly spherical outer shell, as the outer shell may be disrupted by surface features, such as the opening 110, etc. Still other modifications which fall within the scope of the present invention will be apparent to those skilled in the art, in light of a review of this disclosure, and such modifications are intended to fall within the appended claims.

1. A robot comprising:
a sphere-like outer shell defining an inner cavity;
an axle unit including an axle connected at its opposed ends to the outer shell, in the inner cavity, and a transmission to transmit a torque to the axle;
a pendulum drive unit operatively connected to the axle unit and supported in the outer shell by the axle, the pendulum drive unit having actuators to produce torque, the actuators operatively connected to the transmission of the axle unit;
wherein the axle unit and the pendulum drive unit concurrently define a cylindrical joint by which the pendulum drive unit is movable in rotation and translation relative to the axle to tilt and drive the sphere-like outer shell via the actuators.

2. The robot according to claim 1, wherein the actuators are bi-directional motors.

3. The robot according to claim 2, wherein the bi-directional motors are the same

4. The robot according to claim 2, including a control unit operating the actuators, such that movements of the pendulum drive unit in rotation and in translation relative to the axle result from a control of directions of rotation of the bi-directional motors.

5. The robot according to claim 2, including a control unit operating the actuators, such that movements of the pendulum drive unit in rotation and in translation relative to the axle resulting from a control of directions of rotation and/or RPM of the bi-directional motors.

6. The robot according to claim 1, wherein the pendulum drive unit includes lead screws receiving a drive from the actuators, the lead screws operatively connected to the transmission of the axle unit to transmit the drive to the axle unit.

7. The robot according to claim 6, wherein the lead screws are meshed with nuts of the transmission such that the nuts are rotatable relative to and/or translatable along the lead screws as a function of a drive of the actuators.

8. The robot according to claim 7, wherein the nuts are part of circular transmission members so as to rotate concurrently with the respective circular transmission members.

9. The robot according to claim 8, wherein the circular transmission members are pulleys, the transmission further including a pulley fixed to the axle, and a belt between the pulleys.

10. The robot according to claim 9, wherein the pulleys are geared pulleys and the belt is a toothed belt.

11. The robot according to claim 1, wherein a transmission ratio between the actuators and the axle unit is the same.

12. The robot according to claim 1, wherein a frame of the pendulum drive unit is slidingly supported to the axle unit by at least one rail.

13. The robot according to claim 1, wherein the axle unit and the pendulum unit are entirely located in a volume of the inner cavity that is below a top 40% of the inner cavity relative to a vertical diameter of the outer shell.

14. The robot according to claim 1, further including a propulsion unit mounted to the pendulum drive unit, and having a peg configured to transmit a force to a ground via an opening in the shell to propel the robot upwardly.

15. The robot according to claim 14, wherein the opening has an elastic membrane supporting a disk, the peg contacting the disk to propel the robot upwardly.

16. The robot according to claim 14, wherein the propulsion unit has a pair of propulsion devices interconnected to a central member, the peg being part of the central member.

17. The robot according to claim 16, wherein the propulsion devices of the pair are located on opposite sides of the axle unit.

18. The robot according to claim 16, wherein the propulsion devices each include a 6-bar mechanism that is spring-biased in flexion to a loaded condition, a release from flexion to extension causing a transmission of the force to the ground.

19. The robot according to claim 16, wherein a release mechanism is mounted to the central member.

20. The robot according to claim 1, wherein the outer shell is transparent.
